(19) United States
(12) Patent Application Publication
(10) Pub. No.: US 2011/0139950 A1
(43) Pub. Date: Jun. 16, 2011

(54) Retention Clip with Two Points of Contact

(75) Inventors: Martin Wai, Carlsbad, CA (US); Eric Bradford, Aptos, CA (US); Barry Lee, Santa Cruz, CA (US)

(73) Assignee: PLANTRONICS, INC., Santa Cruz, CA (US)

(21) Appl. No.: 12/638,859

(22) Filed: Dec. 15, 2009

(51) Int. Cl. F16M 13/00

(52) U.S. Cl. 248/231.81; 248/226.11

(57) ABSTRACT

A clip for holding a portable electronic device comprises a retaining structure adapted to receive and retain the portable electronic device and a clip structure coupled to the retaining structure for clipping the retaining structure to something. The clip structure applies forces at two, spaced apart locations, thereby to resist rotation of the clip in use.

### BACKGROUND OF THE INVENTION

Electronics devices continue to shrink in size, form and weight, allowing the devices to be conveniently portable. For example, MP3 players and mobile phones continue to decrease in size without losing the features and functionality of their home counterparts. Often it is preferred or necessary that devices are immediately accessible or visible to the user when carried. A common solution is to clip the device to a shirt or other clothing accessory; such as a belt or purse. Clips can be fastened to many surfaces and are conveniently detachable, making them an ideal solution to wearing portable electronics devices.

### SUMMARY OF THE INVENTION

According to one aspect of the invention, a clip for holding a portable electronic device comprises a retaining structure adapted to receive and retain the portable electronic device and a clip structure coupled to the retaining structure for clipping the retaining structure to something. The clip structure applies forces at two, spaced apart locations, thereby to resist rotation of the clip in use.

In one embodiment, the clip structure comprises a first spring member extending in a first direction and a second spring member coupled to the first spring member and extending in a second direction that is generally opposite to the first direction. The first spring member is coupled at a first end to the retaining structure and has a contact area at a second end. The second spring member extends in a direction from the second end towards the first end. The second spring member has a contact area adjacent to the first end of the first spring member.

In another embodiment, a base member is coupled to the retaining structure and to the first spring member at a first end. The first spring member has a contact area at a second end, and the second spring member extends in a direction from the second end towards the first end. The second spring member may comprise one or more springs. The retaining structure comprises a pocket for receiving the boom of the headset. The first and second spring members may be formed from a folded strip of metal or from a folded wire.

In another embodiment, the clip structure comprises a first cantilever spring coupled to the retaining structure at a first end thereof and having a contact area at the second end thereof. A second cantilever spring is coupled to the first cantilever spring at the second end of the first cantilever spring and having a contact area located towards the first end of the first cantilever spring. The second cantilever spring may comprise two or more strips of spring material. The first and second cantilever springs may be formed from a folded strip of metal or from a folded wire. As before, the retaining structure comprises a pocket for receiving the boom of the headset.

In another embodiment, the clip structure comprises a base member coupled to the retaining structure and to a first cantilever spring at a first end. The first cantilever spring has a contact area at the second end thereof. The second cantilever spring is coupled to the first cantilever spring at the second end of the first cantilever spring and has a contact area located towards the first end of the first cantilever spring. The second cantilever spring may comprise two or more strips of spring material. As before, the retaining structure comprises a pocket for receiving the boom of the headset. Also as before, the first and second cantilever springs may be formed from a folded strip of metal or from a folded wire.

In another embodiment, the ratio between the forces is substantially constant. The ratio may remain constant through a range of equivalent deflections caused by the thickness of the material being clipped. In one aspect, the forces may be substantially equal.

### BRIEF DESCRIPTION OF THE DRAWINGS

FIG. 1 is a perspective view of a headset and a clip according to one embodiment of the invention.

FIG. 2 is an illustration of the clip of FIG. 1 in use.

FIG. 3 is a perspective view of the clip structure of FIG. 1.

FIG. 4 is a side view of the clip structure of FIG. 3.

FIG. 5 is a perspective view of an alternate embodiment of the clip structure.

FIG. 6 is a side view of the alternate embodiment of the clip structure of FIG. 5.

FIG. 7 is an alternative embodiment of the clip structure of FIG. 1.

### DETAILED DESCRIPTION OF THE DRAWINGS

The following description is presented to enable any person skilled in the art to make and use the invention. Description of specific embodiments and applications are provided only as examples and various modifications will be readily apparent to those skilled in the art. The general principle defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purposes of clarity, details relating to technical materials that are known in the technical fields related to the invention have not been described in detail as not to unnecessarily obscure the present invention.

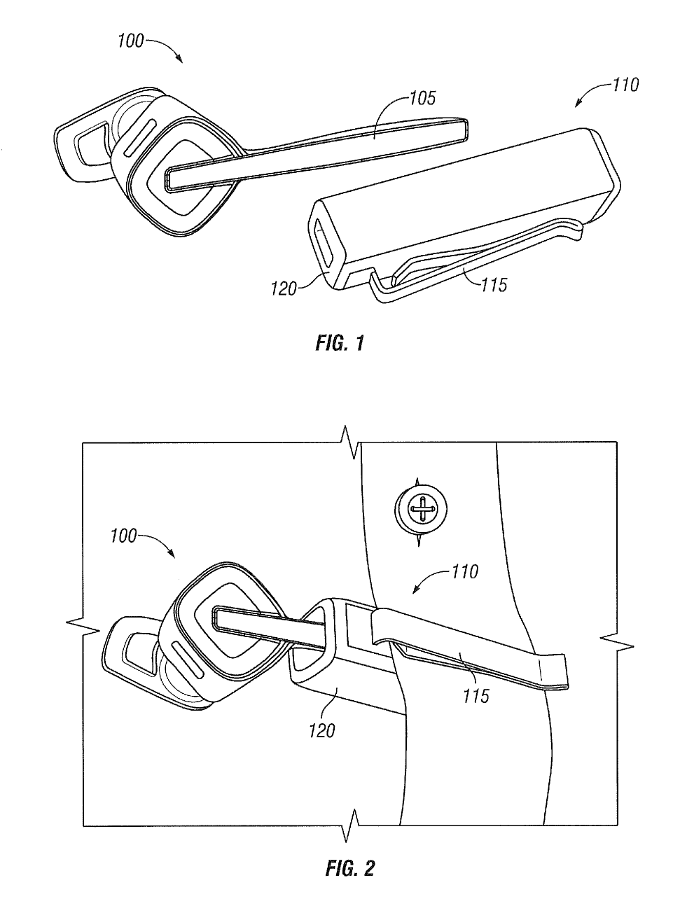

Referring to FIG. 1, shown is a headset 100 and a clip 110 according to one embodiment of the invention. The headset 100 comprises a boom 105. The clip 110 comprises a clip structure 115 and a retaining structure 120.

The boom 105 is received and retained by a pocket formed in the retaining structure 120. The pocket is shaped and sized to receive the boom 105, and may be sized to provide a light frictional engagement with the boom 105. The frictional engagement may be provided by a lining within the pocket, for example a rubber lining or fabric-covered foam.

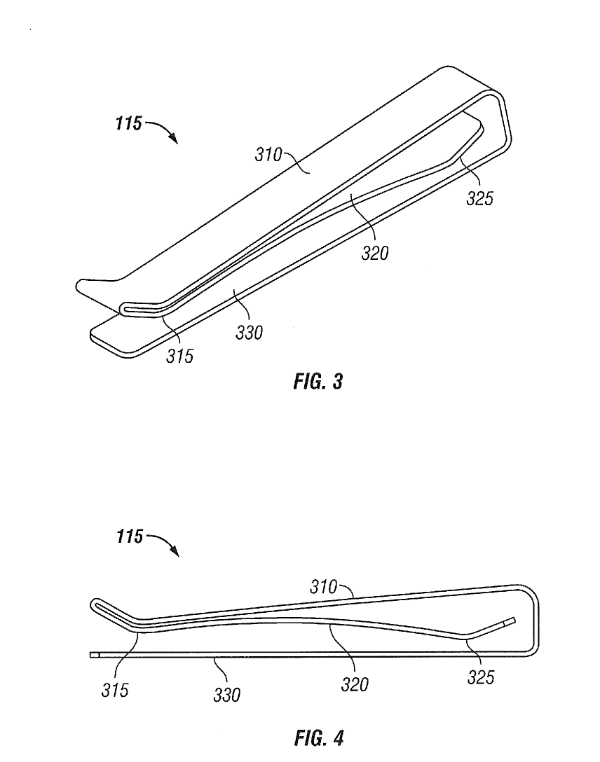

The retaining structure 120 is coupled to the clip structure 115 to provide a clipping means to clip the retaining structure 120 to an object such as a shirt, belt or a purse. In one embodiment, the retaining structure 120 is made of plastic and the clip structure 115 is molded into the retaining structure 120. Alternatively, the retaining structure 120 may be formed with a slot for receiving the base 330 (see FIGS. 3 and 4) of the clip structure 115.

In a preferred embodiment, the retaining structure 120 is provided with a leather sheath. A slit is cut into the leather prior to assembly. The base 330 of the clip structure 115 is inserted through the slit and then the leather and the clip structure 115 are glued to the main body of the retaining structure 120.

Referring to FIG. 2, shown is an illustration of the clip 110 in use. Clip 110 is clipped horizontally to the placket of a dress shirt by the clip structure 115. The applied forces to the dress shirt at a first contact area 315 and a second contact area 325 (see FIGS. 3 and 4) that is spaced apart from the first contact area 315 causes the clip 110 to resist pivoting under the weight of the headset 100, which reduces the possibility of having the headset 100 fall out of the retaining structure 120. Also, the resistance of the clip 110 to pivoting may provide a more consistent positioning of the clip in use, which may be advantageous when the performance of the device is dependent on its positioning, e.g. when it includes a microphone or speakers.

This resistance to pivoting is particularly useful when the device's center of gravity is not between the contact areas, as is the case with the headset 100, as the weight of the device will urge the clip 110 to rotate about the contact areas. However, the presence of two contact areas may be useful to provide leverage against the center of gravity of the device if it is not located between the contact areas 315, 325.

Referring to FIG. 3, shown is the clip structure 115 made of metal strip according to one embodiment of the invention. The clip structure 115 comprises a first spring member 310, a first contact area 315, a second spring member 320, a second contact area 325, and a base 330.

The first spring member 310 extends in one direction and is coupled at a first end to the base 330. The first spring member 310 has a first contact area 315 at a second end for applying forces to an object such as a shirt, belt or a purse. The second spring member 320 is coupled to the first spring member 310 and extends in a direction opposite to the first contact area 315. The second spring member 320 has a second contact area 325 for applying forces to an object such as a shirt, belt or a purse. The applied forces at the first contact area 315 and second contact area 325 causes the clip 110 to resist pivoting as described above.

Referring to FIG. 4, shown is a side view of the clip structure 115 made of metal strip in FIG. 3. The relationship between the clip structure 115 and the retaining structure 120 is typically arranged such that the contact areas 315, 325 are biased towards the retaining member when the clip 110 is not in use. That is, the clip structure 115 is pretensioned in its relationship with the retaining structure 120 so that a clipping force is applied in use no matter how thin the object to which the clip 110 is applied.

Additionally, by varying the widths of the first and second spring members 310, 320 along their lengths, or choosing different thicknesses for the first and second spring members 310, 320, the forces and the relationships between the forces applied at the contact areas 315, 325 can be adjusted as desired for the particular implementation In one embodiment, the widths of first and second spring members 310,320 can be chosen such that the forces applied at contact areas 315,325 is proportional to the clipped item's thickness. For example, if the clip structure 115 is designed such that the forces are substantially equal, the clip structure 115 may apply 0.5 pounds at the first contact area 315 and 0.5 pounds at the second contact area 325 when a dress shirt is clipped but for a thicker item, such as a leather jacket, the forces may be 1.0 pounds at the first contact area 315 and 1.0 pounds at the second contact area 325. In another embodiment, the forces applied at first contact area 315 and second contact area 325 may be substantially different.

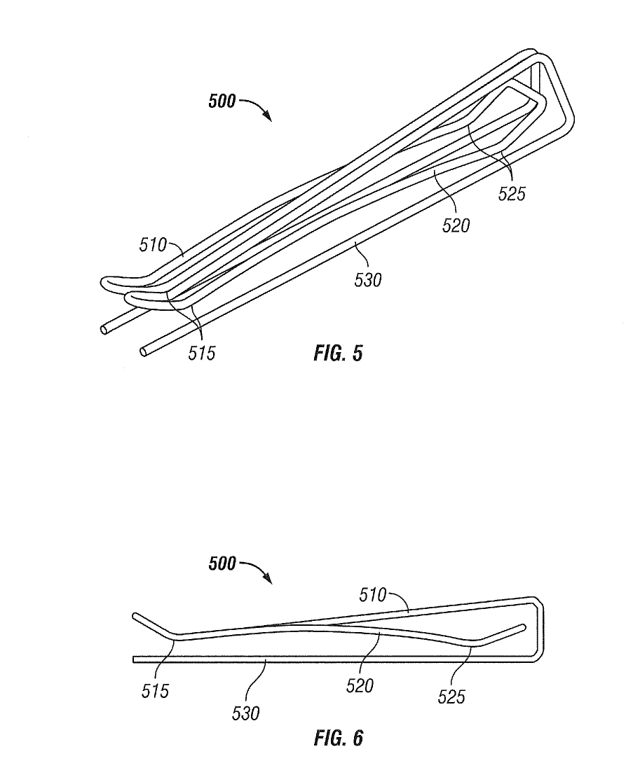

Referring to FIG. 5, shown is a clip structure 500 made of wire according to one embodiment of the invention. The clip structure 500 comprises a first spring member 510 which comprises two arms, a first contact area 515, a second spring member 520, a second contact area 525, and a base 530.

Referring to FIG. 6, shown is a side view of the clip structure 115 made of wire in FIG. 5.

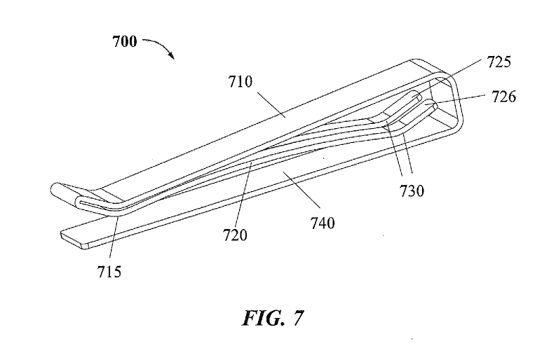

Referring to FIG. 7, shown is a clip structure 700 made of a metal strip according to one embodiment of the invention. The clip structure 700 comprises a first spring member 710, a first contact area 715, a second spring member 720 comprising two springs 725,726, a second contact area 730, and a base 740.

In use, a user clips the clip 110 (with or without the headset 100 in place in the retaining structure 120) to an object such as his or her shirt, belt or purse. For example, the user may slide his shirt between the clip structure 115 and the retaining structure 120. The applied forces at the first contact area 315 and second contact area 325 hold the clip in place on the user's shirt and resist pivoting. The user can then insert or remove the headset 100 at his convenience. Once the clip 110 is clipped on the user's shirt with the headset 100 in place, he may now locate the headset 100 immediately for a telephone call since it is visible and easily accessible. The same is true when the user is finished with a telephone call and wishes to take off the headset 100 and store it in the retaining structure 120.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, instead of the retaining structure comprising a pocket for receiving all or part of the electronic device, the retaining structure may be in the form of a bracket or cage with clips or other structures for engaging the electronic device. Additionally, the clip may be formed integrally with an electronic device, in which case the housing forms the retaining structure of the clip. In such a case, the electronic device itself is clipped and unclipped as needed. In summary, the scope of the invention should not be restricted to the specific exemplary embodiments disclosed herein, and all modifications that are readily suggested to those of ordinary skill in the art should be included within the spirit and scope of the invention.

1. A clip for holding a portable electronic device, comprising:
a retaining structure adapted to receive and retain the portable electronic device; and
a clip structure coupled to the retaining structure for clipping the retaining structure to something, the clip structure applying forces at two, spaced apart locations, the two forces applied generally in the same direction, thereby to resist rotation of the clip in use.

2. The clip of claim 1 wherein the clip structure comprises:
a first spring member extending in a first direction, and
a second spring member coupled to the first spring member and extending in a second direction that is generally opposite to the first direction.

3. The clip of claim 2 wherein the first spring member is coupled at a first end to the retaining structure and has a contact area at a second end, and the second spring member extends in a direction from the second end towards the first end.

4. The clip of claim 3 wherein the second spring member has a contact area adjacent to the first end of the first spring member.

5. The clip of claim 2 wherein a base member is coupled to the retaining structure and to the first spring member at a first end, the first spring member has a contact area at a second end, and the second spring member extends in a direction from the second end towards the first end.

6. The clip of claim 2 wherein the first and second spring members are formed from a folded strip of metal.

7. The clip of claim 2 wherein the first and second members are formed from a folded wire.

8. The clip of claim 2 wherein the retaining structure comprises a pocket for receiving the boom of a headset.

9. The clip of claim 2 wherein the second spring member comprises one or more springs.

10. The clip of claim 1 wherein the clip structure comprises:
a first cantilever spring coupled to the retaining structure at a first end thereof and having
a contact area at the second end thereof, and
a second cantilever spring coupled to the first cantilever spring at the second end of the first cantilever spring and having a contact area located towards the first end of the first cantilever spring.

11. The clip of claim 10 wherein the first and second cantilever spring are formed from a folded strip of metal.

12. The clip of claim 10 wherein the first and second cantilever spring are formed from a folded wire.

13. The clip of claim 10 wherein the retaining structure comprises a pocket for receiving the boom of a headset.

14. The clip of claim 10 wherein the second cantilever spring comprises two or more strips of spring material.

15. The clip of claim 1 wherein the clip structure comprises:
a base member coupled to the retaining structure and to a first cantilever spring at a first end, the first cantilever spring having a contact area at the second end thereof, and
a second cantilever spring coupled to the first cantilever spring at the second end of the first cantilever spring and having a contact area located towards the first end of the first cantilever spring.

16. The clip of claim 15 wherein the first and second cantilever springs are formed from a folded strip of metal.

17. The clip of claim 15 wherein the first and second cantilever springs are formed from a folded wire.

18. The clip of claim 15 wherein the retaining structure comprises a pocket for receiving the boom of a headset.

19. The clip of claim 15 wherein the second cantilever spring comprises two or more strips of spring material.

20. The clip of claim 1 further comprising a support member and the forces are a function of the distance between the clip structure and support member.

21. The clip of claim 20 wherein a ratio between the forces is substantially constant for a range of equivalent distances between the clip structure and support member.

22. The clip of claim 21, wherein the forces are substantially equal.
